(19) United States
(12) Patent Application Publication
(10) Pub. No.: US 2004/0047305 A1
(43) Pub. Date: Mar. 11, 2004

(54) Distributed reverse channel outer loop power control for a wireless communications system

(76) Inventor: Fatih Ulupinar, San Diego, CA (US)

Correspondence Address: Qualcomm Incorporated, Patents Department, 5775 Morehouse Drive, San Diego, CA, 92121-1714, US

(21) Appl. No.: 10/228,538

(22) Filed: Aug. 27, 2002

(51) Int. Cl. H04B 7/216; H04J 3/16

(52) U.S. Cl. 370/320; 370/470

(57) ABSTRACT

A distributed power control mechanism having multiple states suitable for use in a wireless communication system. In one aspect, the mechanism includes a distributed adjustment unit comprising data processor, state machine, frame error rate adjuster, and power control threshold adjustment element, where the frame error rate adjuster may be centrally located, such as at a system controller. The data processor receives and processes an input signal to provide status of input signal data frames. The state machine receives frame status and provides a current power control state. The frame error rate adjuster receives frame status and provides an effective current frame error rate. The threshold adjustment element receives frame status, effective current frame error rate, and current power control state and provides a power control setpoint in response thereto.

### BACKGROUND

1. Field

The present invention relates generally to the field of wireless communication systems, and more specifically to techniques for performing distributed power control of the reverse link outer loop.

2. Background

Cellular telecommunications systems, such as Code Division Multiple Access (CDMA) systems, are often characterized by a plurality of mobile stations, or terminals (e.g. cellular telephones, mobile units, wireless telephones, or mobile phones) in communication with one or more Base Station Transceiver Subsystems (BTSs). Signals transmitted by the terminals are received by a BTS and often relayed to a Mobile Switching Center (MSC) having a Base Station Controller (BSC). The MSC, in turn, routes the signal to a Public Switched Telephone Network (PSTN) or to another terminal. Similarly, a signal may be transmitted from the PSTN to a terminal via a BTS and an MSC.

CDMA systems are typically designed to conform to one or more standards. Such standards include the “TIA/EIA/IS-95-B Mobile Station-Base Station Compatibility Standard for Dual-Mode Wideband Spread Spectrum Cellular System” (the IS-95 standard), the “TIA/EIA/IS-98 Recommended Minimum Standard for Dual-Mode Wideband Spread Spectrum Cellular Mobile Station” (the IS-98 standard), the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), and the “TR-45.5 Physical Layer Standard for cdma2000 Spread Spectrum Systems” (the cdma2000 standard). New CDMA standards are continually proposed and adopted for use. These CDMA standards are known to those skilled in the art.

In a typical communications system, proper operation requires that the terminal transmit at the lowest possible power level to minimize interference between terminals. Conversely, if the terminal power level is too low, the BTS will be unable to properly receive and decode packets received from the terminals. This tradeoff requires constant monitoring and maintenance of the transmission power of each individual terminal. Optimal performance occurs when each terminal transmits at the minimum power that allows for proper decoding of the reverse frames at the BTS. Movement of the terminal relative to the BTS, interference effects, and handoffs from one BTS to another can adversely affect and degrade system power performance and the quality of communications.

Previous techniques for controlling power have addressed two distinct attributes of the aforementioned wireless communications system, namely an inner loop power control between the terminal and the BTS, and an outer loop power control at the BSC. Inner loop power control refers to controlling the power level transmitted by the terminal to the BTS, monitoring of the signal power level received by the BTS, and the commands transmitted from the BTS to the terminal to maintain an acceptable terminal transmission power level. Inner loop power control operates such that the BTS endeavors to keep the power perceived by the BTS as close as possible to a fixed, preset power control threshold. The BTS typically sends adjustment commands to the terminal at a relatively high rate, such as 600 times per second. Outer loop power control at the BSC comprises continuously adjusting the power control threshold used by the inner loop power control to achieve an acceptable frame error rate (FER) on the reverse link as observed by the BTS performing the power control. Outer loop power control at the BSC entails the BSC transmitting identical power control setpoints to all BTSs, where the power control setpoints may change depending on FERs transmitted by the BTSs. The power control setpoints are typically computed based on a target FER, which may differ from but form part of the acceptable frame error rate.

The problems with outer loop power control at the BSC include latency, loading, and performance differences between BTSs. Using outer loop power control at the BSC, the BSC must typically wait for all BTSs to transmit packets before computing the power control setpoint and transmitting the power control setpoint to the BTSs. This latency can adversely affect power transmission and network performance, in that late delivery of the power control setpoint to the BTSs may cause the BTSs to employ an improper frame error rate, and may result in increases in frame error rates throughout the system. Transmission latency of the power control setpoint to the BTSs can ultimately result in terminals transmitting at too high or too low a power level, degrading system performance. The requirement for the BSC to transmit identical power control setpoints to each individual BTS provides a significant system load, and this BSC to BTS transmission capacity could be employed for other tasks. Further, in a network using multiple types of BTSs, the threshold value for a, for example, one percent FER may translate into different performance for different BTSs. The centralized BSC algorithm sets the PCT for each BTS to the same value, which may result in different frame error rates for BTSs manufactured to different power control specifications.

There is therefore a need in the art for an efficient power control technique that avoids the previously known drawbacks of latency, transmission loading, and inefficiencies due to BTS manufacturing and performance differences.

### SUMMARY

Embodiments disclosed herein address the above stated needs by providing a system for controlling power level transmission in a wireless communication system. According to a first aspect of the present invention, there is provided a system for controlling power level transmission in a wireless communication system, comprising a distributed adjustment unit operative to receive and process an input communication signal and provide a power control setpoint. The distributed adjustment unit comprises a received data processor operative to receive the input communication signal and provide a frame status for frames of the input communication signal, a power control state machine operative to receive the frame status from the received data processor and provide a current power control state, and a power control threshold adjuster receiving the frame status from the received data processor, the current power control state from the power control state machine, and an effective current frame error rate from a central processor and provide the setpoint in response thereto. The central processor receives the frame status and a target frame error rate and periodically computes the effective current frame error rate and distributes the effective current frame error rate to at least one distributed adjustment unit in the wireless communication system.

According to a second aspect of the present invention, there is provided a wireless communication system, comprising a central processor comprising an error rate adjuster and a distributed adjustment unit. The system comprises an RF receiver unit operative to receive a modulated signal over a wireless communication link and to condition the received signal to generate a conditioned signal, a channel processor operative to receive and process the conditioned signal to provide frame status for data received from the modulated signal for a particular data transmission, and a distributed power control processor operative to receive the frame status and provide an effective current frame error rate in response thereto. The error rate adjuster receives the frame status and computes the effective current frame error rate and transmits the effective current frame error rate to the distributed power control processor of the distributed adjustment unit. Further, the distributed power control processor comprises a distributed threshold adjustment element operative to receive the frame status, a target frame error rate, and the effective current frame error rate and provide the effective current frame error rate in response thereto.

According to a third aspect of the present invention, there is provided a power control unit for use in a wireless communication system. The power control unit comprises a distributed data processor operative to receive and process an input signal to provide status of frames of data received from the input signal for a particular data transmission, a distributed state machine operative to receive the frame status and provide a current power control state for the power control unit. The current power control state is indicative of a status of a particular communication session comprising the data transmission, and the current power control state is one of a plurality of possible states for the power control unit. The power control unit further comprises a central error rate adjustment element operative to receive frame status and provide an effective current error rate in response thereto and a distributed power control threshold adjustment element operative to receive frame status, error rate, and the current power control state and to provide a power control setpoint in response thereto.

According to a fourth aspect of the current invention, there is provided a method of providing power control of a transmitted signal in a wireless communication spectrum. The method comprises receiving and processing the transmitted signal to provide frame status for frames of data received from the received and processed signal for a particular data transmission at a distributed adjustment unit, centrally computing an effective current frame error rate based on the frame status and a predetermined set of criteria and providing the effective current frame error rate to the distributed adjustment unit, and adjusting a power control setpoint in response to frame status and the error rate adjustment factor.

According to a fifth aspect of the present invention, there is provided a computer program embodied on a computer readable medium for providing power control of a transmitted signal in a wireless communication system. The computer program comprises a distributed data processing code segment comprising an input signal processor having the ability to receive an input signal and provide frame status data for the input signal, a central error rate adjustment code segment comprising a correction adjustment computational segment and boundary evaluation segment, wherein a target error rate is corrected using the correction adjustment computational segment as bounded by the boundary evaluation segment, and a distributed power control threshold adjustment segment comprising a correction application segment that corrects a power control threshold setpoint based on the frame status and the error rate adjustment.

According to a sixth aspect of the present invention, there is provided a system for providing power control for a transmitted signal in a wireless communication spectrum. The system comprises a distributed adjustment unit receiving means for receiving and processing the transmitted signal to provide frame status for frames of data received from the received and processed signal for a particular data transmission, central frame error rate adjustment means for determining an effective current frame error rate based on the frame status and a predetermined set of criteria, and distributed adjustment means for adjusting a power control setpoint in response to frame status and the effective current error rate.

According to a seventh aspect of the present invention, there is provided a distributed adjustment unit operative to receive and process an input communication signal and provide a power control setpoint, said distributed adjustment unit. The distributed adjustment unit comprises a received data processor operative to receive the input communication signal and provide a frame status for frames of the input communication signal, a power control state machine operative to receive the frame status from the received data processor and provide a current power control state, and a power control threshold adjuster receiving the frame status from the received data processor, the current power control state from the power control state machine, and an effective current frame error rate from a central processor and provide the setpoint in response thereto.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a diagram of a spread spectrum communication system that supports a number of users communicating via terminals that interact with a set of BTSs;

FIG. 2 is a diagram of a prior reverse link power control system;

FIG. 3 is a diagram of a reverse link power control system in accordance with the present invention;

FIG. 4 is a diagram that illustrates an example of the elements of computing the effective current frame error rate transmitted by the frame error rate adjuster to the power control threshold adjustment block;

FIG. 5 is a diagram that illustrates the adjustment of the power control setpoint for a particular communication session between the terminal and the BTS;

FIG. 6 is a diagram that of a set of power control states according to one aspect of the present invention;

FIG. 7 is a diagram of the interaction of the power control layer with certain subsystems within the BTS;

FIG. 8 is a block diagram of an aspect of the terminal; and

FIG. 9 is a block diagram of an aspect of the BTS.

### DETAILED DESCRIPTION

Definitions. The term “HDR system” or “HDR” as used herein refers to a high data rate system, such as that disclosed in U.S. patent application Ser. No. 08/963,386, entitled “METHOD AND APPARATUS FOR HIGH DATA RATE PACKET DATA TRANSMISSION,” filed Nov. 3, 1997, assigned to the assignee of the present invention. This HDR design forms the basis for TIA/EIA/IS-856, “CDMA2000 High Rate Packet Data Air Interface Specification,” which is known to those skilled in the art.

An HDR subscriber station, referred to herein as an access terminal (AT), or terminal, may be mobile or stationary, and may communicate with one or more HDR base stations, referred to herein as BTSs. A terminal transmits and receives data packets through one or more BTSs to an HDR base station controller, referred to herein as a base station controller (BSC). BTSs and BSCs are parts of a network called an access network. An access network transports data packets between multiple terminals. The access network may be further connected to additional networks outside the access network, such as a corporate intranet or the Internet, and may transport data packets between each terminal and such outside networks. An terminal that has established an active traffic channel connection with one or more base station transceivers is called an active terminal, and is said to be in a traffic state. A terminal in the process of establishing an active traffic channel connection with one or more BTSs is said to be in a connection setup state. A terminal may be any data device that communicates through a wireless channel or through a wired channel, for example using fiber optic or coaxial cables. A terminal may further be any of a number of types of devices including but not limited to PC card, compact flash, external or internal modem, or wireless or wireline phone.

The term “communication channel/link” is used exclusively herein to mean a single route over which a signal is transmitted described in terms of modulation characteristics and coding, or a single route within the protocol layers of either the BTS or the terminal.

The term “reverse channel/link” is used exclusively herein to mean a communication channel/link through which the terminal sends signals to the BTS.

The term “forward channel/link” is used exclusively herein to mean a communication channel/link through which a BTS sends signals to a terminal.

The term “Active Set” is used exclusively herein to mean the set of Pilot Channels associated with the CDMA channels containing Forward Traffic Channels assigned to a particular terminal. The term “Pilot Channel” is used exclusively herein to mean an unmodulated, direct-sequence spread spectrum signal transmitted continuously by each CDMA BTS.

The present system is described in terms of an implementation in an HDR environment. It will be apparent to those skilled in the art that the present invention may be implemented in various communications systems, including but not limited to a CDMA system in accordance with TIA/EIA/IS-95 and its progeny.

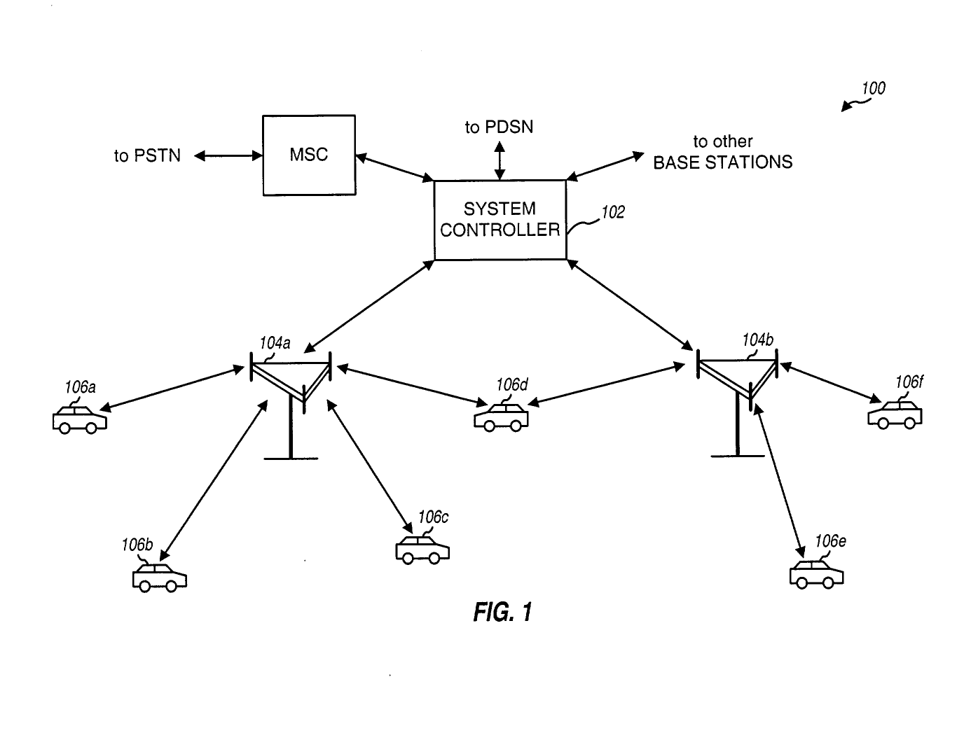

System Operation. FIG. 1 is a diagram of a spread spectrum communication system 100 that supports a number of users. System 100 provides communication for a number of cells, with each cell being serviced by a corresponding BTS 104. Various terminals 106 are dispersed throughout the system. Each terminal 106 can communicate with one or more BTS 104 on the forward and reverse links at any particular moment, depending on whether the terminal is transmitting and/or receiving data and whether it is in soft handoff. As shown in FIG. 1, BTS 104a communicates with terminals 106a, 106b, 106c, and 106d and BTS 104b communicates with terminals 106d, 106e, and 106f.

In system 100, a system controller 102 couples to BTSs 104 and may further couple to an MSC, and then to a PSTN, and/or to a PDSN. System controller 102 provides coordination and control for the various BTSs coupled to it. System controller 102 further controls the routing of data or telephone calls among terminals 106, and between terminals 106 and the PSTN (e.g., conventional telephones), via BTSs 104. For a CDMA system, system controller 102 is also referred to as a base station controller (BSC).

Communication between a particular terminal 106 and one or more BTSs 104 is typically non-continuous. The terminal typically only transmits data to and/or receives data from the BTS(s) 104 for certain particular time periods. At remaining time periods, the terminal 106 is “inactive” and may only be receiving the pilot signal(s) from the BTS(s) 104.

As noted above, on the reverse link, the transmission from each terminal 106 acts as interference to other active terminals and thus affects the performance of these terminals 106. To improve the performance of the terminals and to increase system capacity, the transmit power of each terminal 106 is controlled to be as low as possible to reduce the amount of interference while still maintaining a particular level of performance for the transmitting terminal. If the received signal quality at the BTS 104 is too poor, the likelihood of decoding the received frame correctly decreases and performance may be compromised (e.g., higher FER). On the other hand, if the received signal quality is too high, the transmit power level is also likely to too high and the amount of interference to other terminals increases, which can degrade the performance of the other terminals.

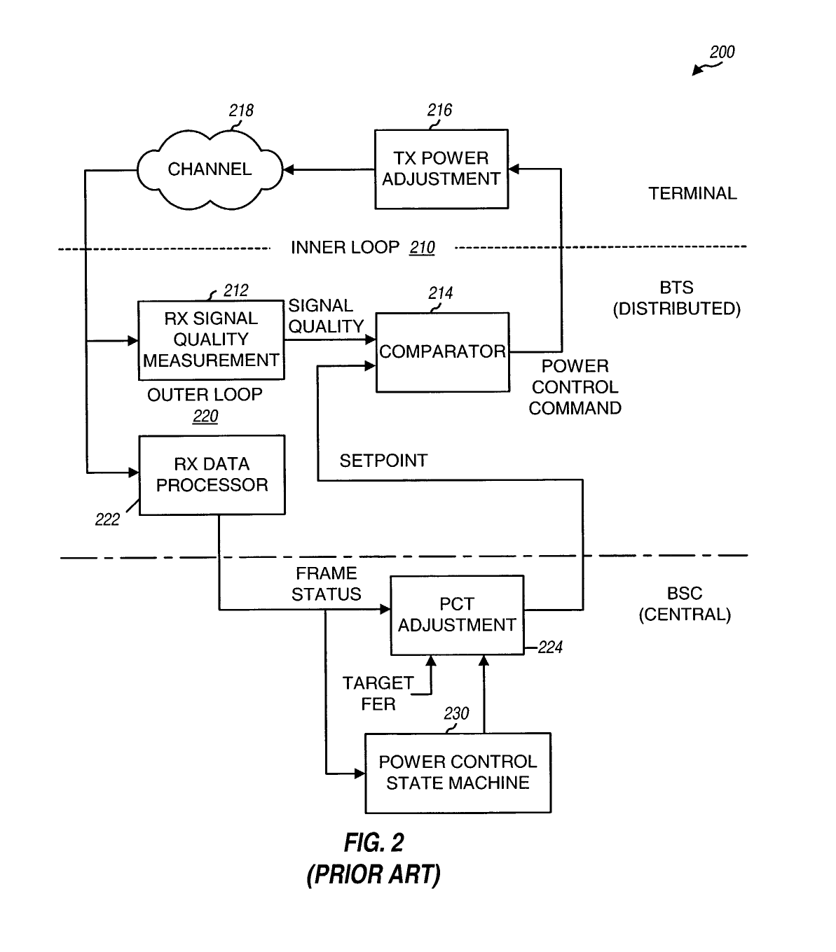

FIG. 2 is a diagram of a prior art system for monitoring the power on the reverse link. The system illustrated in FIG. 2 is disclosed in U.S. patent application Ser. No. 09/615,355, entitled “MULTI-STATE POWER CONTROL MECHANISM FOR A WIRELESS COMMUNICATION SYSTEM,” assigned to the assignee of the present invention. Power control mechanism 200 includes an inner loop 210 that operates in conjunction with outer loop 220.

Inner loop 210 is a (relatively) fast loop that attempts to maintain the signal quality received at the BTS 104 for the terminal 106 as close as possible to the setpoint transmitted from the BSC 102. As shown in FIG. 2, inner loop 210 operates between the terminal 106 and BTS 104. The power adjustment for inner loop 210 is typically achieved by measuring the quality of the received signal at the BTS 104 (block 212), comparing the measured signal quality against the setpoint (block 214), and sending a power control command to the terminal 106. The power control command directs the terminal 106 to adjust its transmit power and may be implemented, for example, as either an “UP” command to direct an increase in the transmit power at the terminal 106 or a “DOWN” command to direct a decrease in the transmit power. The terminal 106 then adjusts its transmit power level accordingly (block 216) each time it receives the power control command. For the HDR system, the power control command may be sent as often as 600 times per second for some CDMA systems, thus providing a relatively fast response time for inner loop 210.

Due to path loss in the communication channel (block 218) that typically varies over time, especially for a terminal 106, the received signal quality at the BTS 104 continually fluctuates. Inner loop 210 thus attempts to maintain the received signal quality at or near the setpoint received from the BSC 102 in the presence of changes in the communication channel.

Outer loop 220 is a (relatively) slower loop that continually adjusts the setpoint transmitted by the BSC 102 such that a particular level of performance is achieved for the terminal 106 on the reverse link. The desired level of performance is typically a particular target frame error rate (FER), which is 1% for some CDMA systems, although some other desired level of performance can also be used.

For outer loop 220, the signal from the terminal 106 is received and processed to recover the transmitted frames and the status of the received frames is then determined (block 222). For each received frame, a determination is made whether the frame is good (i.e., received correctly) or bad (i.e., received in error). Based on the status of the received frame (either good or bad), the setpoint is adjusted at PCT adjustment block 224. Typically, if a frame is received correctly, the received signal quality from the remote terminal is likely to be higher than necessary. The setpoint transmitted from the BSC 102 is thus reduced slightly, which may cause inner loop 210 to reduce terminal transmit power level. Alternatively, if a frame is received in error, the received signal quality from the terminal is likely to be lower than necessary. The setpoint transmitted from the BSC 102 is thus increased, which may cause inner loop 210 to increase terminal transmit power level.

The setpoint can be adjusted for each frame. The frame status can also be accumulated for N received frames and used to adjust the setpoint every Nth frame period, where N can be any integer greater than one. Since inner loop 210 is typically adjusted many times each frame period, inner loop 210 has a faster response time than outer loop 220. The state of the power control mechanism is maintained by a power control state machine 230 that directs the operation of outer loop 220 from a remote location, namely the BSC 102. States available in the design of FIG. 2 may include, but are not limited to, an inactive state representing no power control activity, a normal state, where frames are transmitted and received on the reverse traffic channel, a no data state, where no frames are transmitted on the reverse traffic channel, and a data start state, where there is a new frame on the reverse traffic channel while in the no data state. In the design of FIG. 2, the setpoint is established by PCT adjustment block 224 and power control state machine 230, both resident on the BSC 102. The setpoint is thus transmitted from the BSC 102 to every BTS 104, resulting in the aforementioned problems of latency, performance variations for BTSs employing different power control designs, and so forth.

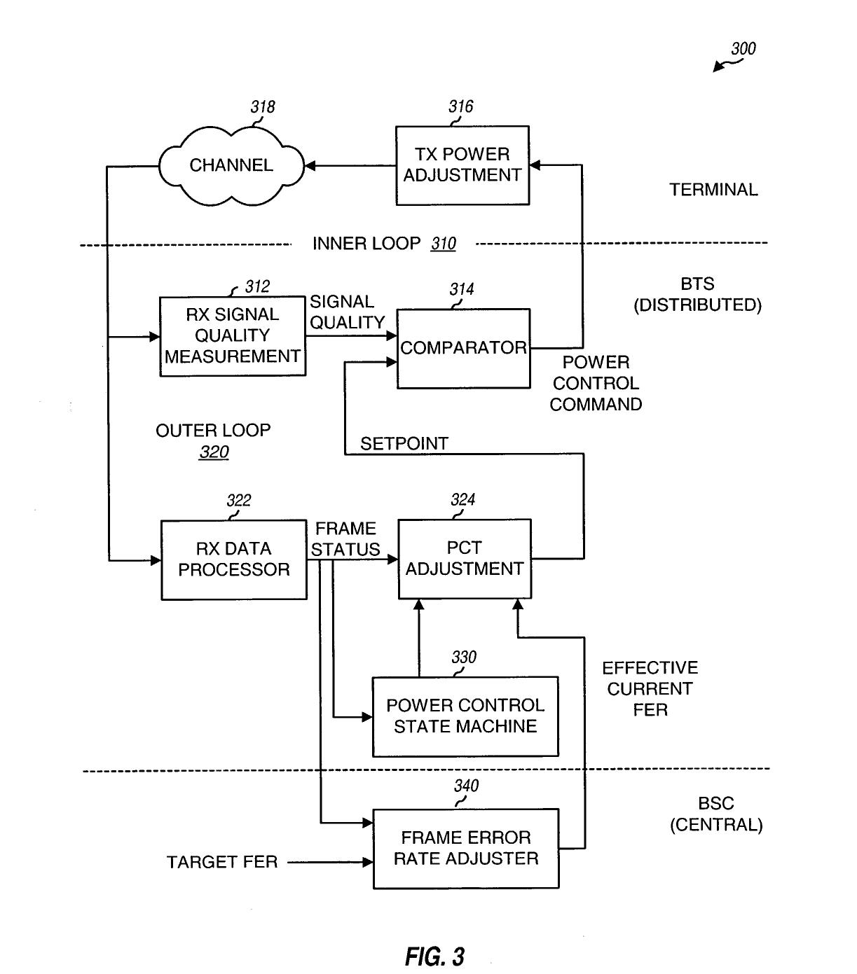

One aspect of the current invention is illustrated in FIG. 3. In this aspect, the inner loop 310 also operates in conjunction with outer loop power control 320. Outer loop power control, including receipt of data from the BSC 102 and transmission of power control commands to the terminal 106, occurs at the BTS 104. The BTS 104 thus represents one of many distributed adjustment units located between the central processor, or BSC 102, and the terminal 106. Each distributed adjustment unit according to the present invention receives data and performs certain functions formerly accomplished on the BSC 102 as well as certain new functions, described below. In this arrangement, the BSC 102 represents a central processor transmitting power control adjustments in the form of an effective current FER to a plurality of distributed adjustment units that interact with a plurality of terminals 106. Each distributed adjustment unit includes, for example, the power control state machine and PCT adjustment block in FIG. 3.

In this arrangement, the BTS 104 typically achieves power adjustment for inner loop 310 by measuring the quality of the received signal at the BTS 104 (block 312), comparing the measured signal quality against the setpoint (block 314), and sending a power control command to the terminal 106. The power control command directs the terminal 106 to adjust terminal transmit power and may be implemented, for example, as either an “UP” command or “DOWN” command to the terminal 106. The terminal 106 then adjusts terminal transmit power level accordingly (block 316) each time it receives the power control command. The power control command may be sent as often as 600 times per second for some CDMA systems, thus providing a relatively fast response time for inner loop 310. Again, inner loop 310 thus attempts to maintain the received signal quality at or near the setpoint received from PCT adjustment block 324 in the presence of changes in the communication channel. Outer loop 320 continually adjusts the setpoint transmitted by the PCT adjustment block 324 such that a particular level of performance is achieved for the terminal 106 on the reverse link.

For outer loop 320, the signal from the terminal 106 is received and processed to recover the transmitted frames and the BTS 104 then determines the status of the received frames in receive data processor block 322. For each received frame, the BTS 104 determines whether the frame is good (i.e., received correctly) or bad (i.e., received in error). Frame status passes from the BTS 104 to the BSC 102, which collects frame status for those BTSs associated with the BSC 102. The BSC 102 uses frame status in combination with a target FER and the total number of BTSs to compute an effective current FER at frame error rate adjustment block 340, discussed below. Frame error rate adjustment block 340 transmits the effective current FER from the BSC 102 to the BTS 104, specifically to the PCT adjustment block 324.

The state of the power control mechanism is maintained by a power control state machine 330 that centrally directs operation of outer loop 320 from within the BTS 104 based on frame status received from receive data processor block 322. As discussed below, states available in the design of FIG. 3 may include, but are not limited to, a normal state, where frames are transmitted and received on the reverse traffic channel, a no data state, where no frames are transmitted on the reverse traffic channel, and a data start state, where there is a new frame on the reverse traffic channel while in the no data state. The power control state machine 330 computes the power control state and provides the power control state to the PCT adjustment block 324. In the design of FIG. 3, the setpoint is established by the PCT adjustment block 324 based on the frame status received from receive data processor block 322, the power control state received from power control state machine 330, both resident on the BTS, and the effective current FER provided by the frame error rate adjustment block 340 resident on the BSC.

Typically, if a frame is received correctly, the received signal quality from the terminal 106 is likely to be higher than necessary. The BTS 104 may reduce the setpoint slightly, which may cause inner loop 310 to reduce the terminal's transmit power level. If a frame is received in error, the received signal quality from the terminal 106 is likely to be lower than necessary, and the BTS 104 may increase the setpoint, which may cause inner loop 310 to increase the terminal's transmit power level. The setpoint can be adjusted for each frame, and frame status can be accumulated for N received frames and used to adjust the setpoint every Nth frame period, where N can be any integer greater than one.

By controlling the manner in which the setpoint is adjusted, different power control characteristics and system performance can be obtained. For example, the received effective current FER can be adjusted by altering the amount of upward adjustment in the setpoint for a bad frame, the amount of downward adjustment for a good frame, the required elapsed time between successive increases in the setpoint, and so on. In one aspect of the present invention, the frame error rate adjustment block 340 operates at the BSC 102, while the receive data processor block 322, PCT adjustment block 324, and power control state machine 330 operate at the BTS 104. As a result, setpoints are dynamically computed at each BTS 104, thereby reducing setpoint computation and transmission latency.

In accordance with one aspect of the invention, the computations, states, adjustments, and related functions for power control are performed by the BTS 104 and the BSC 102 to promote efficiencies between the components in controlling power throughout the system. Individual functions performed, states employed, and calculations made are outlined below.

BSC Power Control Functionality. The power control layer of the BSC employs the frame error rate adjustment block 340 to compute the effective current FER based on the target FER. The desired effect of the frame error rate adjustment block is that the FER computed based on the received frame status from all BTSs approaches or meets the target FER. The target FER is typically set to one percent, but this can be set to other values depending on the requirements of the system while still within the scope of the present invention. The BSC 102 continuously updates the effective current FER sent to the BTSs based on the CRC (cyclic redundancy check) status of the received frame. An HDR frame is good if it has a successful CRC, and is bad if it has an unsuccessful CRC.

The BSC 102 at frame error rate adjustment block 340 computes certain boundaries for the frame error rate, namely the outer boundaries Fmin and Fmax and the narrower theoretical boundaries Femin and Femax. The BSC 102 updates frame error rate adjustment boundaries Fmin, Fmax, Femin, and Femax, based on the active set size, where the active set size is the number of BTSs with which the terminal is currently communicating. These frame error rate boundaries, as discussed in more detail below, provide the upper and lower limits for the effective current FER provided by the BSC 102 to the BTSs 104. The BSC power control system typically updates internal variables, namely those variables used within frame error rate adjustment block 340, such as adjustments applied when good or bad frames are received, the effective current FER, minimum and maximum calculated FER values, and so forth, at the frame rate. The BSC 102 typically does not update the BTSs 104 for every updated frame, but instead transmits updates to the BTSs 104 when the frame error rate adjustment changes exceed a predetermined threshold.

In the present configuration, different BTSs may have different FERs, and the frame status for each received frame is provided by every BTS 104 to the BSC 102. The BSC 102 uses the frame status received from all BTSs 104 to compute a current FER, called Fc. The amount of correction that should be applied to Fc when a good frame is received is Cg, while the amount of correction applied when a bad frame is received is Cb. Cg is calculated as follows:

$$Cg = \frac{Pr ( Ft ) * Cb}{( 1 - Pr ( Ft ) )}$$

where Pr(x) converts a dB value to a linear probability value according to Pr(x)=10^{(x/10)}, Pr(x) ranging from zero to one. Ft is the target frame error rate in dB that should be observed at the BSC 102. Ft may take different values depending on circumstances, including but not limited to Ft having a value of −20, representing one bad frame per one hundred frames received. Cb is the bad frame correction value applied to the currently calculated FER, Fc, when a bad packet is received. Cb may take different values depending on desired performance and conditions encountered, including but not limited to a value of −2, representing a bad frame correction value of 2 dB applied when a bad frame is received.

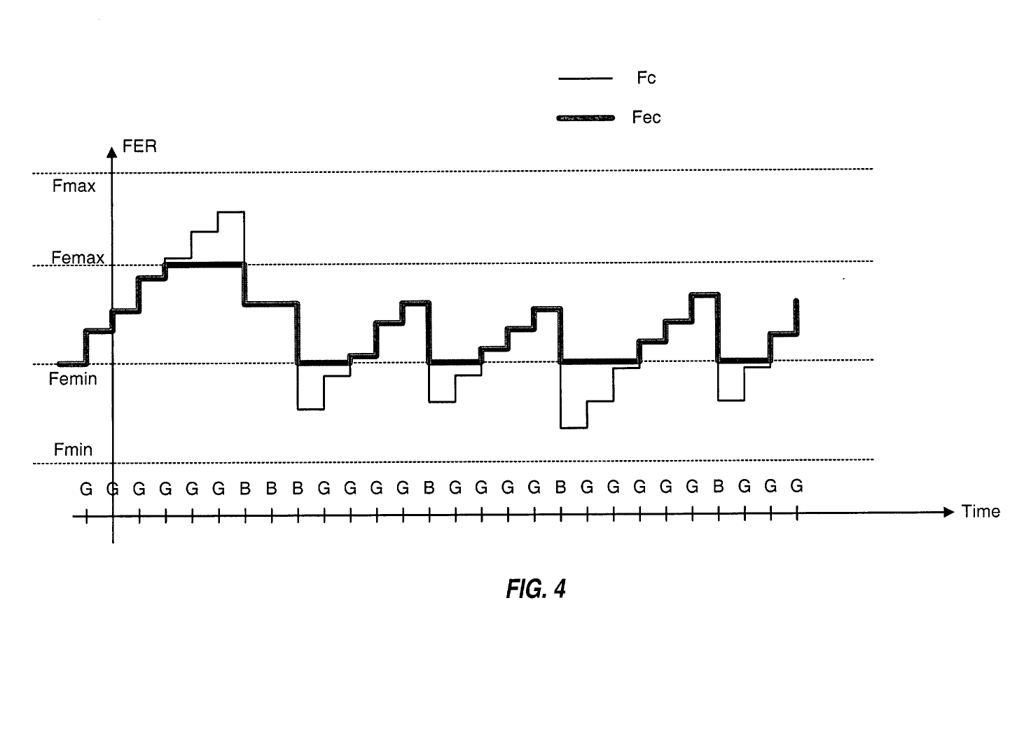

The BSC 102 performs various computations and sends the Fec, or effective current FER, to the BTSs 104. Fc represents the frame error rate computed by the frame error rate adjustment block 340 based on the status of frames received. Fec is a probability value that is represents Fc clipped within the range of [Femin, Femax] according to Fec=min(max(Femin, Fc), Femax). The relationship between Fc, Fec, Fmax, Femax, Femin, and Fmin is illustrated in FIG. 4. Fec is the final value transmitted from the BSC 102 to all the BTSs 104. According to FIG. 4, the range [Fmin, Fmax] is calculated from [Femin, Femax] using the Guard variable as follows:

Fmin=Femin−Guard

Fmax=Femax+Guard

As shown in FIG. 4, Fc varies within a larger range than Fec. The value of Guard depends on the circumstances faced by the particular system, and varies according to the computed range of Femin and Femax discussed below. As an example, the value of Guard may be 2, representing a 2 dB difference between Femin and Fmin, as well as a 2 dB difference between Femax and Fmax.

In operation, Fc may reach a calculated maximum or minimum point (Fmax or Fmin). Once the BSC 102, and specifically the frame error rate adjustment block 340, determines that Fc is at Fmax or Fmin, the frame error rate adjustment block 340 the typically corrects Fc once a frame having opposite status, good or bad, is received at the BSC 102. In other words, when Fc reaches Fmax, for example, and a bad frame is received, the system corrects for the bad frame by decreasing Fc. This may cause the value of Fc used to determine the effective current FER to differ from the Fc that would exist if boundaries were not employed. To accommodate this effect, Fc is permitted to vary within a relatively large range, [Fmin, Fmax]. FIG. 4 illustrates an example of possible changes for Fc and Fec according to the received packet, where G is a good packet that passes CRC and B is a bad packet that fails CRC. From FIG. 4, Fc varies in a wider range than Fec.

The frame error rate adjuster 340 at the BSC 102 calculates Fec boundaries as follows. Femin may be set equal to Ft, the target FER. Femax depends on the number of terminals in soft handoff at each BTS 104. Femax represents the theoretical maximum FER that can be set at all BTSs while still observing the target FER at the BSC 102. Femax typically occurs when all BTSs receive uncorrelated signals at equal levels from the terminal 106. A terminal 106 may be in soft handoff with Ns BTSs, where Ns essentially represents the number of BTSs receiving frames transmitted by one terminal 106. In this situation, Femax equals:

$$Fe max = {( Ft )}^{( \frac{1}{Ns} )}$$

When the terminal 106 is not in soft handoff, Ns is one, Femax equals Femin, and the BTS 104 operates at the same target FER as the BSC 102. For example, if the target FER is 0.01, Femin is 0.01. If the terminal 106 is not in soft handoff, Ns is one, and Femax is 0.01. If a terminal 106 is in soft handoff with two BTSs 104, Femin is again 0.01 and Femax is 0.1.

Thus the present invention computes Fmin, Fmax, Femin, and Femax according to the equations outlined above. The frame error rate adjustment block 340 determines Fc based on the frame status received from the BTSs. In this aspect of the present invention, Fc is calculated as Fc=Fc+Cb, clipped to the range [Fmin, Fmax] when a bad frame is received, and Fc=Fc+Cg clipped to the range [Fmin, Fmax] when a good frame is received. The correction factors Cb and Cg are as outlined above.

As noted above, each frame is designated good or bad depending on the CRC check for the frame. In the situation where the terminal 106 is in soft handoff between Ns BTSs, the BSC 102 receives between 0 and Ns frames for a single frame sent by one terminal, as the frame propagates through more than one BTS 104 to the BSC 102. The BSC 102 processes the frame as good as soon as it receives the first indication from any BTS 104 that the frame is good. In the situation where the frame is bad, all BTSs 104 receiving the frame must pass the bad frame designation to the BSC 102. Some BTSs may also be unable to decode the frame and would be unable to compute the CRC for the missing frame. If the BSC 102 waits for the indication that the frame is bad from all Ns BTSs, it could miss processing the frame and send an incorrect effective frame error rate to the BTSs. In the soft handoff condition, the BSC 102 frame error rate adjuster 340 runs the risk of receiving less than Ns full frames and waiting indefinitely for the remainder. In one aspect of the present invention, the BSC 102 declares the frame as bad after waiting until the next full frame is received from the BTS(s), or alternately waits until one frame of time has elapsed. At either point, the BSC 102 declares the frame as bad, processes the frames, determines the boundaries Fmax, Fmin, Femax, and Femin, and computes Fc and Fec as described.

BTS Power Control Functionality. In accordance with an aspect of the invention, the BTS 104 calculates the setpoint used for inner loop power control. The PCT adjustment block 324 of the BTS 104 seeks the setpoint that will provide a setpoint as close to the effective current FER set by the BSC as possible. The setpoint changes continuously over time to accommodate for changes in the conditions of the terminal 106, and in one aspect of the current invention the setpoint may change as frequently as every 26 milliseconds.

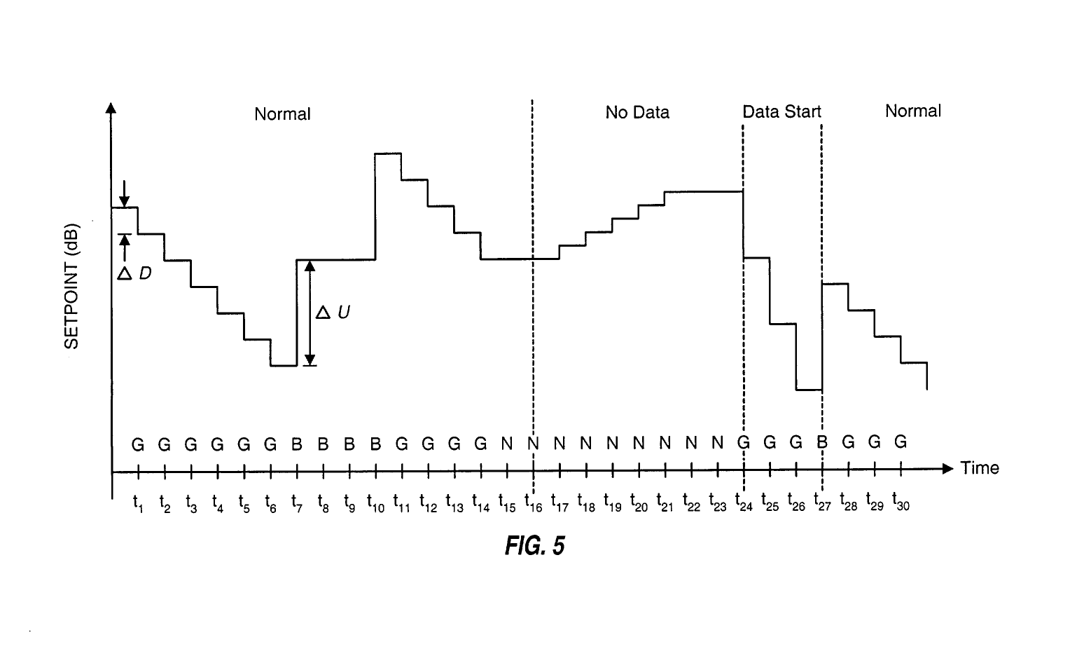

FIG. 5 illustrates a typical setpoint curve, where the BTS 104 and more specifically the PCT adjustment block 324 changes the setpoint based in part on the status of frames received on the reverse traffic channel and the power control state as provided by the power control state machine 330 at the BTS 104. A frame is good if it has a successful CRC (cyclic redundancy check), and bad if it has an unsuccessful CRC. In FIG. 5, the letters on the time axis indicate the status of the received frame for that time period, where G is a good frame, B is a bad frame, and N is no frame received during that time period. In this aspect of the BTS 104, it is acceptable to declare a frame as “no frame received,” and no processing or timing occurs as described above with respect to the BSC 102.

In FIG. 5, the horizontal axis represents time and each lettered segment represents one segment of time, represented by indices t₁, t₂, and so on, through t₃₀ (not shown). The time period between successive time indices is the duration of a received frame, which is also referred to as a “frame period”. The vertical axis represents the resultant setpoint transmitted by PCT adjustment block 324, in units of decibels (dB).

In the example shown in FIG. 5, the distributed adjustment unit operates in the different states noted at the top of the Figure. At each of time indices t₁ through t₆, the frame received from the terminal 106 is determined to be good (G), and the setpoint is decreased by a particular small amount (ΔD). At time index t₇, the received frame is determined to be bad (B) and the setpoint is increased by a particular large amount (ΔU). Generally, ΔD and ΔU depend on circumstances and conditions encountered, and setting these values may be done by one having skill in the art. As shown in FIG. 5, the magnitude of ΔD is generally less than the magnitude of ΔU.

In a specific implementation, in the Normal state, a particular time period needs to elapse between successive increases in the setpoint. Increasing the setpoint on every bad frame may make the power control mechanism unstable and not updating it often enough may make it sluggish. In this example, two consecutive bad frames need to be received between the frames on which the setpoint is increased. Thus, although three consecutive received frames are determined to be bad at time indices t₇ through t₉, the setpoint is only increased at time index t₇ and two time indices later at t₉, but not at time index t₈. At each of time indices t₁₀ through t₁₃, a good frame is received and the setpoint is again decreased accordingly.

In one aspect of the invention, the power control state machine 330 and PCT adjustment block 324 transition from the Normal state to the No Data state if no frames are received within a particular time period, which is two frame periods in this example. Thus, after the second frame period in which no data is received, the power control state machine 330 and the PCT adjustment block 324 transition to the No Data state.

In one aspect, while in the No Data state, the PCT adjustment block 324 may increase the setpoint by a particular small amount after each frame period in which no data is received, up to a particular maximum aggregate amount. In another aspect, the power control state machine 330 and the PCT adjustment block 324 transition from the No Data state to the Data Start state upon receiving a good frame from the terminal 106. In this state, the PCT adjustment block 324 may decrease the setpoint by ΔD for each received good frame. In yet another aspect, the power control state machine 330 and the PCT adjustment block 324 transition from the Data Start state to the Normal state upon receiving a bad frame from the terminal. Upon receiving a bad frame, the power control mechanism transitions to the Normal state and the setpoint is increased by ΔU. The power control state machine 330 and the PCT adjustment block 324 then continue to operate in the Normal state in the manner described above.

The PCT adjustment block 324 of the invention, and specifically the power control adjustment aspect of the system, can be implemented within one or more base stations 104 in communication with the terminal 106, the system controller 102, some other elements of system 100, or a combination thereof.

As mentioned above, the PCT adjustment block 324 used to perform power control adjustment and transmit a setpoint operates in association with the power control state machine using a number of discrete states. Each state indicates communication status between the terminal 106 and the BTS 104, such as whether or not the terminal 106 is active, has been transmitting for a period of time, has resumed transmitting after a period of silence, etc. Each state can also be associated with particular rules for adjusting the inner and/or outer loop. In the design presented in FIG. 3, the state of the PCT adjustment block 324 is maintained by the power control state machine 330 directing BTS outer loop operation. The states and rules are described in further detail below.

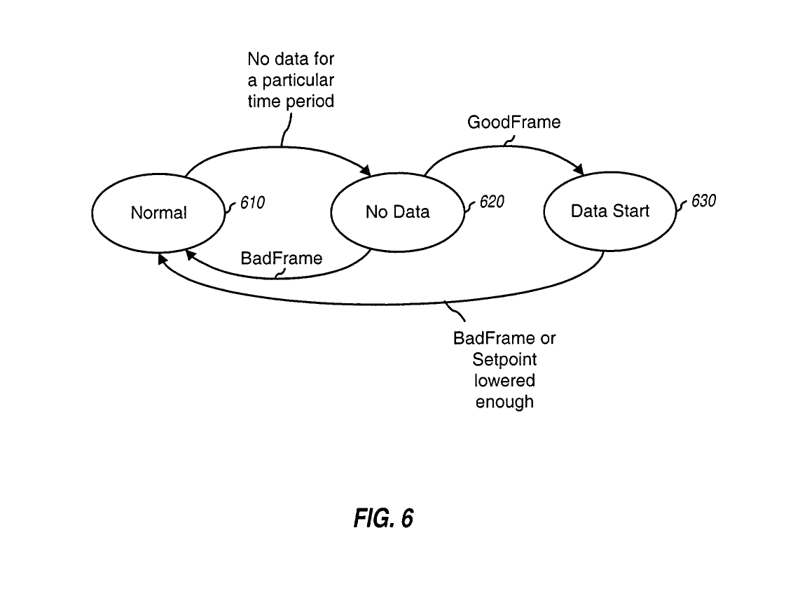

Power Control States. FIG. 6 is a state diagram for the BTS power control system, encompassing the power control state machine 330 and the PCT adjustment block 324, in accordance with a specific aspect of the present invention. According to FIG. 6, the power control system includes Normal state 610, No Data state 620, and Data Start state 630. Greater or fewer number of states and/or different states may be provided for the BTS portion of the power control system while still within the scope of the present invention.

The No Data state 620 indicates no frames are transmitted on the reverse traffic channel. The BTS power control design begins in the No Data state 620 and remains in the No Data state until the BTS 104 receives a frame from the terminal 106. If the received frame is good, the distributed power control system transitions to Data Start state 630. If the received frame is bad, the system transitions to Normal state 610. When in the Data Start state 630 and either a frame is bad or the PCT is lowered below a particular threshold, the system transitions from the Data Start state 630 to the Normal state 610.

The Normal state 610 indicates the terminal 106 is transmitting to and receiving data traffic from the BTS 104. The BTS power control system enters the No Data state 620 when the terminal 106 ceases transmissions for a period of time, typically 0.5 sec. In the No Data state 620, the BTS 104 may receive multiple bad frames from the terminal 106, and in response the BTS 104 may slowly increase the setpoint. This slow increase constitutes an attempt to compensate for a degradation of the air link, so that when the terminal 106 begins transmitting, the packet has a better probability of succeeding, or having sufficient power to reach the BTS 104. The BTS power control system enters the Data Start state 630 when the BTS begins receiving data while in the No Data state 620. In the Data Start state 630, the BTS power control system lowers the setpoint faster than normal for every good frame received until the BTS power control system lowers to the level existing at the initiation of the No Data state 620. This lowering to the No Data state initiation value provides for erosion of the extra increase of the setpoint in the No Data state 620.

Soft Handoff Processing. A soft handoff, referenced above, is characterized by a terminal 106 commencing communications with a new BTS 104 on the same frequency before terminating communications with the old BTS 104. In operation, all BTSs in a terminal's Active Set perform closed loop power control. Each BTS 104 compares the measured signal quality with the setpoint at comparator 314. If the measured signal is greater than the setpoint, each BTS transmits a power control message to the terminal 106 to decrease the transmit power. Alternatively, if the measured signal is below the setpoint, each BTS 104 transmits a power control message for the terminal 106 to increase terminal transmit power. In one aspect, the power control message is implemented with one power control bit sent on the RPC channel (RPC bit). An AP transmits a ‘0’ (“up”) RPC bit if the measured signal is below the setpoint, and a ‘1’ (“down”) RPC bit if the measured signal is greater than the setpoint. The terminal 106 adjusts terminal transmit power by increasing output power if the RPC bits received from all controlling BTSs are ‘0’ (“up”). If any RPC bit received from the controlling BTSs is ‘1’ (“down”), the terminal 106 decreases terminal transmit power.

A sector at BTS 104 experiencing a reverse link with low quality metric causes the sector to send “up” RPC bits. A sector at BTS 104 experiencing a reverse link with good quality metric causes the sector to send “up” and “down” commands that will on average maintain the reverse link's quality metric. Because a terminal 106 decreases reverse link transmit power if one of all RPC bits is “down”, the reverse link transmit power of the terminal 106 is effectively controlled by the sector BTS with lower forward link quality metric during a soft handoff between two BTSs.

Under these soft handoff conditions, a terminal may, for example, be in a two way handoff from BTS1 to BTS2. BTS1 is initially the power controlling BTS. BTS2 will in these conditions likely receive many CRC failures for frames received from the terminal 106. As a result, the power control processing at BTS2 will cause BTS2 to transmit setpoints indicating the terminal 106 should increase its power, and will likely transmit a command for the terminal 106 to transmit at the maximum power allowable. When the terminal moves and BTS2 becomes the power controlling BTS, the power control setpoint transmitted by BTS2 and encountered by the terminal will be the maximum possible. At this point, BTS2 will receive will receive good frames from the terminal and will decrease the setpoint by ΔD, and transmit this decreased setpoint to the terminal. Because of the gradual degradation associated with multiple applications of ΔD, the terminal will, for a certain length of time, be transmitting at a heightened power level. The result is that the terminal will be a source of interference for other terminals in the sector.

Degradation Factor. The present system addresses this shortcoming associated with soft handoff by altering the amount of setpoint increase for each bad frame and accounting for signal degradation for a signal received by a BTS in a soft handoff situation. The problem is addressed by providing a degradation factor D, which decreases the amount of setpoint increase available for a BTS that is not the power controlling BTS. This lower setpoint increase at the non-power controlling BTS decreases the probability that the BTS will transmit power at a maximum value when the BTS 104 transitions from the non-power controlling BTS to the power controlling BTS.

In operation, for the non-power controlling BTS, the amount of setpoint increase for each bad frame is designated B_e, which is the product of D multiplied by B. D is a degradation factor and B is the original, unaltered amount the power controlling BTS 104 would increase the setpoint upon receipt of a bad frame. The degradation factor D varies between zero and one, where D approaches zero when the BTS is not the power controlling BTS and approaches one when the BTS is the power controlling BTS. All BTSs in the terminal's Active Set, power controlling and non-power controlling, employ this degradation factor D in computing the setpoint transmitted to the terminal 106. Alternate methods to calculate D may be employed, including the received signal based D calculation and the RPC mean based D calculation.

The received signal based D calculation determines the actual received Ecp/No and the current setpoint. Ecp/No is the ratio of terminal power signal received at the BTS to the noise received. As the Ecp/No value tends to change rapidly, Ecp/No is filtered using a filter, such as an Infintie Impulse Response (IIR) filter with a time constant covering approximately two frames. The filtered Ecp/No is E_f and the current PCT is PCT_c. In the power controlling BTS in a soft handoff situation, E_f would typically approach PCT_c. D is calculated as:

$$D = \{ \begin{matrix}1 & if & PCT\_c \leq E\_f + E\_a \\ 1 - ( PCT\_c - E\_f ) / R\_f & if & PCT\_c ∈ [ E\_f + E\_a , E\_f + R\_f ] \\ 0 & if & PCT\_c \geq E\_f + R\_f\end{matrix}$$

where E_a and R_f are configuration parameters. E_a represents the allowed difference between E_f and PCT_c such that the BTS still remains the power controlling BTS. The value of E_a depends on the system and may be calculated based on circumstances faced by the system. R_f represents the gradual degradation for reducing D based on the difference between the filtered received Ecp/No and the current PCT value. In this arrangement, D becomes zero when the filtered E_f is less than the corrected PCT value minus R_f. Under typical circumstances, depending on system conditions and other parameters, R_f may vary between approximately 0.5 and 1.0 dB.

The degradation factor D may alternately be computed using a reverse power control (RPC) mean based calculation. The mean of the RPC indicates whether the BTS is the power controlling BTS. A BTS generating mostly commands to increase power indicate the BTS is not the power controlling BTS. A power controlling BTS tends to send an equal number of “up” and “down” commands during an interval. In the RPC mean based degradation computation scheme, an “up” command is represented by plus one, and a “down” command by minus one. The value of RPC may be filtered using, for example, a filter such as an IIR filter having a time constant extending roughly two frames, but other filtering schemes may be employed. In operation, when the terminal 106 is primarily in communication with one BTS 104, the filtered RPC (RPC_f) is roughly zero for the power controlling BTS due to an approximately equal number of plus one and minus one commands, and one for a non-power controlling BTS, due to a majority of plus one commands. The value of the degradation factor, D, is calculated as:

$$D = \{ \begin{matrix}1 & if & RPC\_f < 0 \\ ( 1 - RPC\_f ) / R\_f & if & RPC\_f ∈ [ 0 , R\_f ] \\ 0 & if & RPC\_f > R\_f\end{matrix}$$

R_f defines the value of gradual degradation, which may be set to different values depending on circumstances, including but not limited to ten percent more than the maximum value allowable for the filtered RPC. From the foregoing example, prior to soft handoff, BTS1 will have an approximately equal number of up and down commands and RPC_f will be approximately zero, yielding a D of one. BTS2 will initially have a significant number of up commands, approaching one, and thus D will initially be zero. If the value allowable for RPC_f is 75 percent, representing three fourths of the setpoint commands being commands to increase power, R_f may be set depending on RPC_f, such as to a value including but not limited to 75 percent or 82.5 percent.

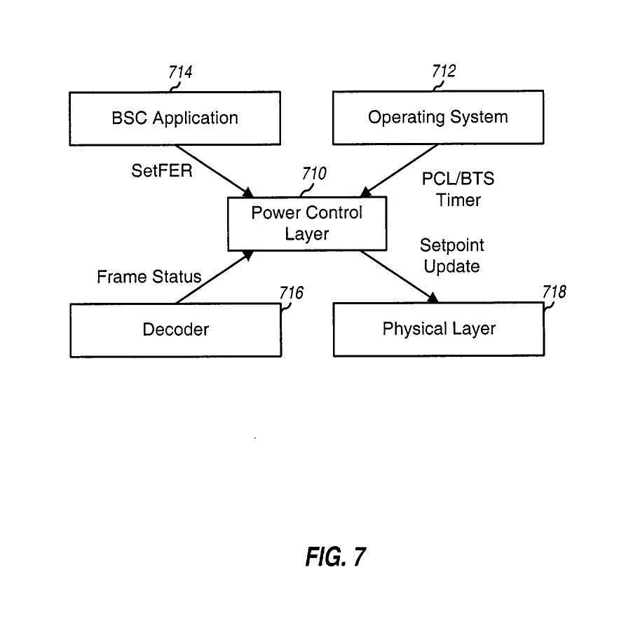

Power Control Layers. FIG. 7 is a diagram of the interaction of the power control mechanism with some of the elements within a BTS, in accordance with an aspect of the invention. The elements of FIG. 7 relate generally to the elements of FIG. 3 but address the power control layer of the BTS and its interaction with other elements of the BTS. In this aspect, the elements associated with the BTS power control layer 710 include an operating system (O/S) 712, a base station controller (BSC) 714, a decoder 716, and a physical layer 718. The operation of the power control mechanism is dependent on the occurrence of various events, some of which are described above. Messages and/or signals notifying the occurrence of these events are typically generated by the various subsystems and forwarded to the BTS power control layer.

Operating system 712 is the operating system for the BTS and is used to provide timing signals for the power control mechanism. Operating system 712 can be directed to provide, for example, a periodic timer (e.g., a power control (PCL_BTS) timer) that goes off every frame interval, used as a triggering signal by the power control mechanism to update variables and perform any required actions. A mechanism that updates the setpoint every frame may be employed.

BSC 714 performs call processing for the BTS and provides a SetFER command to the BTS power control layer 710 causing the BTS to use the new effective current FER. The decoder 716 provides the status of a particular frame, while the physical layer 718 receives the setpoint transmitted by the BTS power control layer 710. The physical layer 718 is responsible for the inner loop power control between the BTS and the terminal.

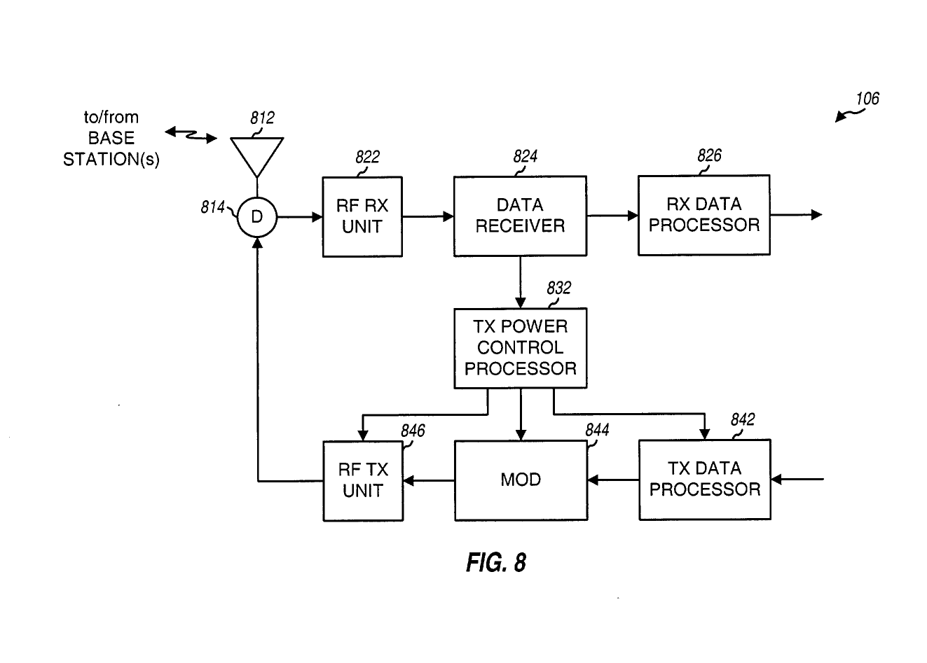

Representative Hardware. FIG. 8 is a block diagram of one aspect of terminal 106. On the forward link, the forward link signal is received by an antenna 812, routed through a duplexer 814, and provided to an RF receiver unit 822. RF receiver unit 822 conditions (i.e., filters, amplifies, downconverts, and digitizes) the received signal and provides samples. A data receiver 824 receives and processes (e.g., despreads, decovers, and pilot demodulates) the samples to provide recovered symbols. Data receiver 824 may implement a rake receiver that processes multiple instances of the received signal and generates combined recovered symbols. A receive data processor 826 then decodes the recovered symbols, checks the received frames, and provides the output data.

On the reverse link, data is received by a transmit (TX) data processor 842 and processed (i.e., formatted, encoded, and/or other functions known to those skilled in the art performed). The processed data is provided to a modulator (MOD) 844 and further processed (e.g., covered, spread, possibly scaled to adjust the transmit signal level, and/or other functions known to those skilled in the art performed). The modulated data is then provided to an RF TX unit 846 and conditioned (e.g., converted to analog signals, amplified, filtered, quadrature modulated, and/or other functions known to those skilled in the art performed) to generate a reverse link signal. The reverse link signal is routed through duplexer 814 and transmitted via antenna 812 to one or more BTSs 104.

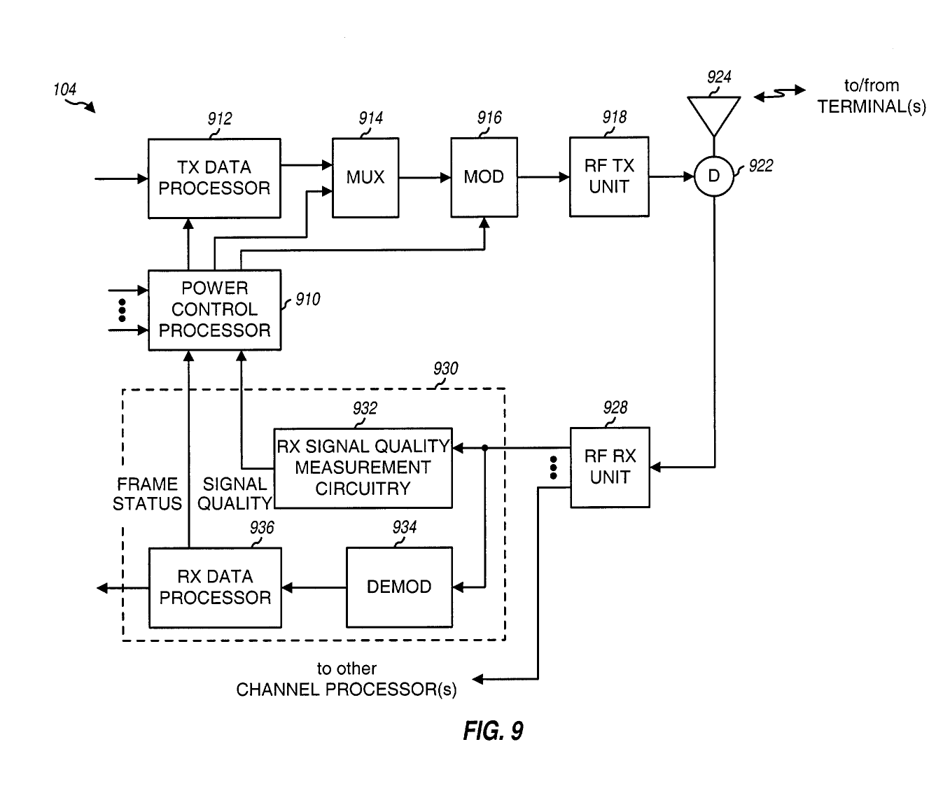

Referring to FIG. 9, on the reverse link, the reverse link signal is received by antenna 912, routed through duplexer 914, and provided to an RF receiver unit 922. RF receiver unit 922 conditions (i.e., downconverts, filters, and amplifies) the received signal and provides a conditioned reverse link signal for each remote terminal being received. RF receiver unit transmits the conditioned reverse signal to data receiver 924, which forwards data to receive data processor 926 for data processing and transmit power control processor 932. Data receiver 924 provides received data to transmit control processor 932. Receive data processor 926 forwards receive data information to other hardware in the BTS for further processing. The BTS provides processed data to transmit data processor 942. Transmit data processor 942 provides processed transmit data to modulator 944, while transmit power control processor 932 provides power control transmission information to transmit data processor 942, modulator 944, and RF transmit unit 946. RF transmit unit provides RF transmit signals to duplexer 914, which sends signals to antenna 912 for transmission.

Power control processor 932 implements the inner and outer loops described above. For the inner loop, power control processor 932 receives the measured signal quality and sends a sequence of power control commands, which can be sent on the forward link transmission, for example, by inserting it via multiplexer 914. For the outer loop, power control processor 932 receives the indication of good, bad, or no frame from data receiver 924 and adjusts the setpoint for the terminal 106 accordingly in the manner described above.

The power control mechanism of the invention can be implemented by various means. For example, power control mechanism can be implemented with hardware, software, or a combination thereof. For a hardware implementation, the elements in the power control mechanism can be implemented within one or more application specific integrated circuits (ASICs), digital signal processors (DSPs), programmable logic devices (PLDs), controllers, micro-controllers, microprocessors, other electronic units designed to perform the functions described herein, or a combination thereof.

For a software implementation, the elements in the power control mechanism can be implemented with modules (e.g., procedures, functions, and so on) that perform the functions described herein. The software code can be stored in a memory unit and executed by a processor (e.g., transmit power control processor 832 in FIG. 8).

Although various aspects and features of the power control mechanism of the invention have been described for the reverse link, some of these aspects and features can be advantageously applied for the forward link power control. For example, the power control mechanism for the forward link can be designed to operate based on a set of states, with the operation of the power control being dependent on the state in which it is operating. The power control on the forward link can also be adjusted in varied steps. It is to be understood that certain steps disclosed herein may be interchanged without departing from the scope of the invention.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. In particular for the present application, while certain blocks and functionality are said to exist at the BTS or at the BSC, it is to be specifically understood that these components and/or this functionality may be located, performed, or otherwise operate in an alternate manner within this hardware and software, other hardware and software, or at different locations within the system illustrated in FIG. 1.

The previous description is provided to enable any person skilled in the art to make or use the present invention. Various modifications to these aspects will be readily apparent to those skilled in the art, and the generic principles defined herein may be applied to other embodiments without departing from the spirit or scope of the invention. Thus, the present invention is not intended to be limited to the aspects presented herein but is to be accorded the widest scope consistent with the principles and novel features disclosed herein.

What is claimed is:

1. A system for controlling power level transmission in a wireless communication system, comprising:
a distributed adjustment unit operative to receive and process an input communication signal and provide a power control setpoint, said distributed adjustment unit comprising:
a received data processor operative to receive the input communication signal and provide a frame status for frames of the input communication signal;
a power control state machine operative to receive the frame status from the received data processor and provide a current power control state; and
a power control threshold adjuster receiving the frame status from the received data processor and the current power control state from the power control state machine; and
a central processor comprising:
a frame error rate adjuster, the frame error rate adjuster receiving the frame status and a target frame error rate and periodically computing the effective current frame error rate and distributing the effective current frame error rate to a plurality of distributed adjustment units in the wireless communication system;
wherein the power control threshold adjuster also receives an effective current frame error rate from the central processor and provides the power control setpoint based on the frame status, the current power control state, and the effective current frame error rate.

2. The system of claim 1, wherein the current power control state is defined based on parameters comprising frame status and a prior state.

3. The system of claim 1, wherein frame status indicates receipt of one from a group comprising a good frame, a bad frame, and no received frame for a corresponding frame period.

4. The system of claim 1, wherein the possible power control states comprise a no data state and a normal state.

5. The system of claim 1, wherein the central processor operates to apply a computed correction factor to a dynamically computed error rate.

6. The system of claim 1, wherein the computed correction factor is based on a target frame error rate.

7. The system of claim 6, wherein the computed correction factor is allowed to vary within a set range.

8. The system of claim 1, wherein the power control threshold adjuster computes an effective correction factor based on a correction factor and a degradation factor.

9. The system of claim 8, wherein the degradation factor is computed based on received signal energy.

10. The system of claim 8, wherein the degradation factor is computed based on received power control mean values.

11. The system of claim 1, wherein the distributed adjustment unit is implemented in a BTS and the central processor is implemented in a BSC.

12. The system of claim 1, wherein said system operates over a CDMA communication system.

13. A wireless communication system, comprising:
a central processor comprising an error rate adjuster; and
a remote adjustment unit comprising:
an RF receiver unit operative to receive a modulated signal over a wireless communication link and to condition the received signal to generate a conditioned signal;
a channel processor operative to receive and process the conditioned signal to provide frame status for data received from the modulated signal for a particular data transmission; and
a distributed power control processor operative to receive the frame status and provide an effective current frame error rate in response thereto;
wherein the error rate adjuster receives the frame status and computes the effective current frame error rate and transmits the effective current frame error rate to the distributed power control processor of the distributed adjustment unit;
and further wherein the distributed power control processor comprises a distributed threshold adjustment element operative to receive the frame status, a target frame error rate, and the effective current frame error rate and provide the effective current frame error rate in response thereto.

14. The wireless communication system of claim 13, wherein the channel processor comprises:
signal quality measurement circuitry operative to receive the conditioned signal and provide an indication of a signal quality for the conditioned signal, and
a data processor operative to receive, demodulate, and decode the conditioned signal to provide the frame status.

15. A power control unit for use in a wireless communication system, comprising:
a distributed data processor operative to receive and process an input signal to provide status of frames of data received from the input signal for a particular data transmission;
a distributed state machine operative to receive the frame status and provide a current power control state for the power control unit, wherein the current power control state is indicative of a status of a particular communication session comprising the data transmission, and wherein the current power control state is one of a plurality of possible states for the power control unit;
a central error rate adjustment element operative to receive frame status and provide an effective current error rate in response thereto; and
a distributed power control threshold adjustment element operative to receive frame status, error rate, and the current power control state and to provide a power control setpoint in response thereto.

16. The power control unit of claim 15, wherein the communication session is characterized by non-continuous data transmission comprising bursts of data transmission separated by periods of no transmission.

17. The power control unit of claim 15, wherein the current state is defined based on parameters comprising frame status and a prior state.

18. The power control unit of claim 15, wherein frame status indicates receipt of one from a group comprising a good frame, a bad frame, and no received frame for a corresponding frame period.

19. The power control unit of claim 15, wherein the possible states comprise a no data state and a normal state.

20. The power control unit of claim 15, wherein the remote error rate adjustment element operates to apply a computed correction factor to a dynamically computed error rate.

21. The power control unit of claim 20, wherein the computed correction factor is based on a target frame error rate.

22. The power control unit of claim 20, wherein the computed correction factor is allowed to vary within a set range.

23. The power control unit of claim 22, wherein the set range depends upon the target error rate.

24. The power control unit of claim 21, wherein the distributed power control threshold adjustment element computes an effective correction factor, wherein the effective correction factor is based on a correction factor and a degradation factor.

25. The power control unit of claim 24, wherein the degradation factor is computed based on received signal energy.

26. The power control unit of claim 24, wherein the degradation factor is computed based on received power control mean values.

27. The power control unit of claim 15, wherein the power control unit is operated to adjust a transmit power level of a reverse link transmission from a terminal to a BTS.

28. The power control unit of claim 15, wherein one or more frames are received for a particular transmitted data frame and wherein the frame status corresponding to the transmitted frame is considered a good frame if at least one of the one or more received frames is determined to be a good frame.

29. The power control unit of claim 15, wherein one or more frames are received for a particular transmitted data frame and wherein the frame status corresponding to the transmitted frame is considered a bad frame if all of the one or more received frames are determined to be bad frames.

30. The power control unit of claim 15, wherein the central error rate adjustment element computes an effective current error rate adjustment and transmits the effective current error rate adjustment to at least one BTS.

31. The power control unit of claim 15, wherein the central error rate adjustment element operates at a BSC and the distributed power control threshold adjustment element operates at a BTS.

32. The power control unit of claim 15, operated on a reverse link data transmission in a CDMA communication system.

33. A method of providing power control of a transmitted signal in a wireless communication spectrum, comprising:
receiving and processing the transmitted signal to provide frame status for frames of data received from the received and processed signal for a particular data transmission at a distributed adjustment unit;
centrally computing an effective current frame error rate based on the frame status and a predetermined set of criteria and providing the effective current frame error rate to the distributed adjustment unit; and
adjusting a power control setpoint in response to frame status and the error rate adjustment factor.

34. The method of claim 33, further comprising determining a current power control state, and wherein said power control setpoint adjusting is further in response to the current power control state.

35. The method of claim 33, wherein centrally computing the effective current frame error rate comprises:
dynamically computing a current frame error rate; and
applying a correction factor to the current frame error rate based on received frame quality and target frame error rate.

36. The method of claim 33, wherein current frame error rate is maintained within a computed bounded limit.

37. The method of claim 33, wherein centrally adjusting the power control setpoint comprises computing an effective bad frame adjustment quantity based on a bad frame adjustment quantity and a degradation factor.

38. The method of claim 37, wherein the degradation factor is based on received signal energy.

39. The method of claim 37, wherein the degradation factor is based on received power control mean values.

40. A computer program embodied on a computer readable medium for providing power control of a transmitted signal in a wireless communication system, comprising:
a distributed data processing code segment comprising an input signal processor having the ability to receive an input signal and provide frame status data for the input signal;
a central error rate adjustment code segment comprising a correction adjustment computational segment and boundary evaluation segment, wherein a target error rate is corrected using the correction adjustment computational segment as bounded by the boundary evaluation segment; and
a distributed power control threshold adjustment segment comprising a correction application segment that corrects a power control threshold setpoint based on the frame status and the error rate adjustment.

41. The computer program of claim 40, further comprising a central power control state computation segment for computing a state based on frame status and providing the state to the power control threshold adjustment segment.

42. A system for providing power control for a transmitted signal in a wireless communication spectrum, comprising:
a distributed adjustment unit receiving means for receiving and processing the transmitted signal to provide frame status for frames of data received from the received and processed signal for a particular data transmission;
central frame error rate adjustment means for determining an effective current frame error rate based on the frame status and a predetermined set of criteria; and
distributed adjustment means for adjusting a power control setpoint in response to frame status and the effective current error rate.

43. The system of claim 42, further comprising distributed power control state determining means for determining a current power control state, wherein said distributed adjustment computing means further operate in response to the current power control state.

44. The system of claim 42, wherein the central frame error adjustment means comprises:
means for dynamically computing a current error rate; and
means for applying a correction factor to the current error rate based on received frame quality and target frame error rate.

45. The system of claim 44, wherein current error rate is maintained within a computed bounded limit.

46. The system of claim 42, wherein the distributed adjustment computing means comprises means for computing an effective bad frame adjustment quantity based on a bad frame adjustment quantity and a degradation factor.

47. A distributed adjustment unit operative to receive and process an input communication signal and provide a power control setpoint, said distributed adjustment unit comprising:
a received data processor operative to receive the input communication signal and provide a frame status for frames of the input communication signal;
a power control state machine operative to receive the frame status from the received data processor and provide a current power control state; and
a power control threshold adjuster receiving the frame status from the received data processor, the current power control state from the power control state machine, and an effective current frame error rate from a central processor and provide the setpoint in response thereto.

48. The distributed adjustment unit of claim 47, wherein the central processor receives the frame status and a target frame error rate and periodically computes the effective current frame error rate and distributes the effective current frame error rate to at least one distributed adjustment unit.

49. The distributed adjustment unit of claim 47, wherein the current power control state is defined based on parameters comprising frame status and a prior state.

50. The distributed adjustment unit of claim 47, wherein frame status indicates receipt of one from a group comprising a good frame, a bad frame, and no received frame for a corresponding frame period.

51. The distributed adjustment unit of claim 47, wherein the possible power control states comprise a no data state and a normal state.

52. The distributed adjustment unit of claim 47, wherein the power control threshold adjuster computes an effective correction factor, and wherein the effective correction factor is based on a correction factor and a degradation factor.

53. The distributed adjustment unit of claim 52, wherein the degradation factor is computed based on received signal energy.

54. The distributed adjustment unit of claim 52, wherein the degradation factor is computed based on received power control mean values.

55. The distributed adjustment unit of claim 52, wherein the distributed adjustment unit provides the setpoint from a BTS to a terminal.

56. A method for providing a transition by a terminal between a first transmitter and a second transmitter, comprising:
receiving frames transmitted by the terminal at the first transmitter and second transmitter;
determining a first frame status at the first transmitter;
determining a second frame status at the second transmitter;
transmitting a first degraded power control command from the first transmitter to the terminal, wherein the first degraded power control command approaches a first ideal power control command when the first transmitter is determined to be the power controlling transmitter and the first degraded power control command approaches zero otherwise, wherein degradation of the first degraded power control command is based in part on the first frame status; and
transmitting a second degraded power control command from the second transmitter to the terminal, wherein the second degraded power control command approaches a second ideal power control command when the second transmitter is determined to be the power controlling transmitter and the second degraded power control command approaches zero otherwise, wherein degradation of the second power control command is based in part on the second frame status.

57. The method of claim 56, wherein degradation of the first power control command and the second power control command are based on received power signal at each transmitter and a current power control command.

58. The method of claim 56, wherein degradation of the first power control command and the second power control command are based on mean reverse power control transmissions by each transmitter.

59. The method of claim 58, wherein mean reverse power control transmissions corresponding to a plurality of commands to increase terminal power indicate the first power control command and second power control command approach zero.

60. The method of claim 56, wherein degradation of the first power control command and second power control command is based on received signal energy.

61. The method of claim 56, wherein degradation of the first power control command and second power control command is based on received power control mean values.
